(19) United States
(12) Patent Application Publication
(10) Pub. No.: US 2011/0200280 A1
(43) Pub. Date: Aug. 18, 2011

(54) SLIDE RING AND/OR STATIONARY SEAL RING OF A RUNNING GEAR SEAL

(76) Inventor: Mathias Grünaug, Kissing (DE)

(21) Appl. No.: 13/057,862

(22) PCT Filed: Jul. 16, 2009
(86) PCT No.: PCT/DE2009/000990

§ 371 Date: Apr. 28, 2011

(30) Foreign Application Priority Data
Aug. 7, 2008 (DE) 10 2008 036 996.9

(51) Int. Cl. F16C 33/02; F16J 15/34

(52) U.S. Cl. 384/416; 277/500

(57) ABSTRACT

The invention relates to a slide ring and/or stationary seal ring of a running gear seal, comprising a base body having an angular cross-section, an axial limb used to receive a spring element, and a radial limb provided with a running surface extending over a predeterminable height, wherein at least the naming surface is provided with a corrosion protection layer, which at the same time forms the sliding layer.

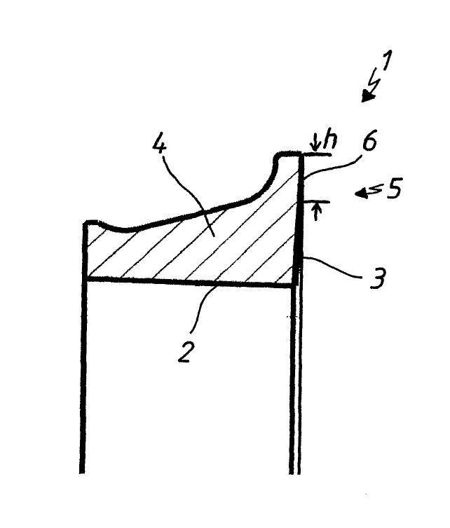

The invention concerns a bearing and/or counter ring of a drive seal, comprising an angular base body in the cross-section.

When conventional drive seals made of chilled iron or steel materials are used in abrasive and corrosive media, particularly in sea water, heavy wear and corrosion of the bearing rings can occur.

Angularly formed bearing and/or counter rings for drive seals with conical seal rings are widely known. These are operatively connected to a round seal ring or a rubber trapezoidal ring.

DE 103 52 675 A1 describes a bearing ring seal and manufacturing procedure for the same. The bearing ring seal formed as a drive seal consists of the metal bearing and/or counter ring, which has a wear protective layer on its running surface area, which is formed by particles of hard material embedded into the running surface. The bearing and/or counter ring is intended to consist of a light alloy, in particular an aluminium alloy. The particles of hard material are formed from grinding powder, which is pressed in or which penetrates by forging, rolling or moulding. This does not provide a corrosion protective layer.

The invention is based on developing a bearing and/or counter ring of a drive seal, so that the corrosion behaviour is improved, in particular for use in abrasive and corrosive media, without the sliding and wear behaviour being negatively influenced.

This problem is solved by means of a bearing and/or counter ring of a drive seal comprising an angular base with an axial journal that is used to fix a spring element, as well as a radial journal equipped with a running surface extending over a predetermined height that is equipped with at least one running surface equipped with a corrosion protective layer, which simultaneously forms the sliding layer.

Further beneficial developments of the bearing and/or counter ring that is the subject of the invention are given in the associated sub-claims.

Depending on applications, further flat areas of the bearing and/or counter ring adjacent to the running surface can also be provided with a corrosion protective layer. According to demand, all areas of the bearing and/or counter ring exposed to corrosion attacks can be equipped with a corrosion protective layer.

It is advantageous for the corrosion protective layer to be applied to the running surfaces or other flat surfaces by electrochemical means, in particular by electroplating.

A further consideration pursuant to the invention is the corrosion protective layer formed by a chrome or chrome ceramic layer.

The use of a galvanic hard chrome layer with a network of cracks extending through the entire thickness of the layer in which solid particles can be incorporated is particularly advantageous. A wide range of solid particles are suitable for this purpose. Using the particles of hard materials is beneficial. In addition to diamond particles, tungsten carbide, chromium carbide, aluminium oxide, silicon carbide, silicon nitride and/or boron carbide are also possible.

Solid lubricant particles can also be incorporated in the cracks as solid particles. Graphite, hexagonal boron nitride and/or PTFE can be advantageous for this purpose.

The thickness of the corrosion protective layer, in particular on the running surface, should be in the 0.01 to 1.0 mm range. A grain size of the incorporated solid particles of between 0.0005 and 0.015 mm is selected. This means that the subject of the invention applies an optimal corrosion protective layer, at least on the running surface of the bearing and/or counter ring, which also forms an optional sliding layer.

The bearing and/or counter ring advantageously consists of a cast material, with which the corrosion protective layer/sliding layer are distinguished on the one hand by a material that is hard in comparison with the base material (cast material) and on the other hand by high corrosion resistance, in particular for use in abrasive and corrosive media, such as sea water, This measure ensures that the drive seal has a long service life.

It is particularly advantageous that the customer's current series production need not be interrupted, since the existing sealing fixtures and round seal rings can continue to be used.

The subject of the invention is presented in a design example in the drawing.

The single illustration shows a bearing and/or counter ring 1 with angular cross-section of a drive seal, more of which is not shown. The base body V of the bearing and/or counter ring 1 has an axial journal 2 and a radial journal 3. A fixture area 4 is located in the axial journal 2 area for a spring element, further details of which are not shown, while a running surface 5 is provide in the radial journal 3 area. This running surface 5 forms the so-called sliding surface.

The base body 1 is meant to consist of cast iron materials in this example. Only the fact that the running surface/sliding surface 5 is covered with a corrosion protective layer 6 is shown. The corrosion protective layer 6 in this example is to be formed by a hard chrome layer, which would be applied to the running surface/sliding surface 5 by electrochemical means.

Depending on use, further flat areas of the radial journal 3, axial journal 2 and the spring element fixture 4 could be equipped with a corrosion protective layer. According to requirements, the corrosion protective layer on running surface 6 and, also according to requirements, on the other flat areas, can have a layer thickness of between 5 and 200 mm.

According to requirements, the galvanic hard chrome layer could be equipped during production with a network of cracks extending through the entire layer thickness, in which a wide range of solid particles could be incorporated. Particles of hard materials such as diamond particles, tungsten carbide, chromium carbide or similar could be used for this purpose. According to requirements, particles of hard materials in the form of solid lubricant particles could also be incorporated in the network of cracks in order to increase sliding qualities. Graphite, hexagonal boron nitride and/or PTFE are suitable for this purpose.

1. Bearing and/or counter ring (1) of a drive seal, comprising an angular base body in the cross-section (1), with an axial journal (2), which is used to fix a spring element, as well as a radial journal (3), equipped with a running surface (5) extending over a predetermined height (h), for which at least the running surface (5) is equipped with a corrosion protective layer (6), which simultaneously forms the sliding layer.

2. Bearing and/or counter ring pursuant to claim 1 characterised in that the corrosion protective layer (6) is also provided for outside the running surface (5) on other flat areas.

3. Bearing and/or counter ring pursuant to claim 1 or 2, characterised in that the corrosion protective layer (6) is applied by electrochemical means, in particular by electroplating, on the running surface (5), and on other flat areas (2 to 4) respectively,

4. Bearing and/or counter ring pursuant to claims 1 to 3, characterised in that the corrosion protective layer (6) is formed by a chrome or chrome ceramic layer.

5. Bearing and/or counter ring pursuant to claims 1 to 4, characterised in that the corrosion protective layer (6) is formed by a galvanic hard chrome layer with a network of cracks extending through the entire thickness of the layer.

6. Bearing and/or counter ring pursuant to claim 5, characterised in that solid particles are also incorporated in the cracks.

7. Bearing and/or counter ring pursuant to claim 5 or 6, characterised in that solid particles are also incorporated in the cracks.

8. Bearing and/or counter ring pursuant to claims 5 to 7, characterised in that the particles of hard materials consist of tungsten carbide, chromium carbide, aluminium oxide, silicon carbide, silicon nitride and/or boron carbide

9. Bearing and/or counter ring pursuant to one of claims 5 to 7, characterised in that diamond particles are also incorporated in the network of cracks.

10. Bearing and/or counter ring pursuant to one of claims 5 to 9, characterised in that solid lubricant particles are also incorporated as solid particles in the network of cracks in order to improve the sliding characteristics.

11. Bearing and/or counter ring pursuant to claims 5 to 10, characterised in that the solid lubricant consist of graphite, hexagonal boron nitride and/or PTFE.

12. Bearing and/or counter ring pursuant to on of claims 1 to 11, characterised in that the thickness of the corrosion protective layer (6), at least in the running surface (5) area, is between 0.01 and 1.0 mm.

13. Bearing and/or counter ring pursuant to on of claims 5 to 12, characterised in that the thickness of the corrosion protective layer (6), at least in the running surface (5) area, is between 0.0005 and 0.015 mm.
